(19) United States
(12) Patent Application Publication
(10) Pub. No.: US 2016/0377257 A1
(43) Pub. Date: Dec. 29, 2016

(54) LENS DEVICE AND LED STRIP LIGHT HAVING SAME

(71) Applicant: Self Electronics Co., Ltd., Ningbo (CN)

(72) Inventors: Bozhang Xu, NINGBO (CN); Huangfeng Pan, NINGBO (CN); Zuping He, NINGBO (CN)

(73) Assignees: Wanjiong Lin, NINGBO (CN); Self electronics USA Corporation, NORCROSS (CN)

(21) Appl. No.: 15/195,374

(22) Filed: Jun. 28, 2016

(30) Foreign Application Priority Data
Jun. 29, 2015 (CN) 201510378356.3

(51) Int. Cl. F21V 5/00; F21V 17/10; F21S 4/28; F21V 5/04

(52) U.S. Cl. CPC F21V 5/008; F21V 5/04; F21V 17/104; F21S 4/28; F21Y 2103/10; F21Y 2115/10

(57) ABSTRACT

A LED strip light includes at least one LED chip and a lens device. The lens device includes at least one optical axis, a diffuser plate, a spread-light lens disposed on the diffuser plate and including a plane light incidence surface being perpendicular to the at least one optical axis, and a first convex light emitting surface and a second convex light emitting surface which are positioned at two sides of the at least one optical axis respectively. On a cross section taken along the at least one optical axis, an arc length and a radius of curvature of a profile of the first convex light emitting surface being larger than that of a profile of the second convex light emitting surface, irradiation distance of emergent light of the first convex light emitting surface being less than that of emergent light of the second convex light emitting surface.

### RELATED APPLICATION

This present application claims benefit of the Chinese Application, CN201510378356.3, filed on Jun. 29, 2015.

### BACKGROUND

1. Technical Field

The present application relates to lighting devices, and more particularly to a lens device and LED strip light having same to form uniform illumination in the illumination area.

2. Description of the Related Art

Light emitting diode (LED) is growing in popularity due to decreasing costs and long life compared to incandescent lighting and fluorescent lighting. LED lighting can also be dimmed without impairing the useful life of the LED light source.

Recently, a number of LED lighting apparatuses have been designed to replace the halogen apparatus, as well as other traditional incandescent or fluorescence lighting apparatuses. But, due to mediocre light output, LED used in the past was primarily limited to applications where only small surface areas were illuminated. Usually, the LED light apparatuses includes at least one lens having unified specification in order to be convenient to centralized purchase and assembly and be ensure uniform illumination along length direction of the LED light apparatuses. Otherwise, illumination region of the LED light apparatuses is larger than the illuminated area so as that light can fully cover the illuminated area. As a result, partial light emitted forward of the two ends of the LED light apparatuses is out of the illuminated area. Therefore, it is not benefit to take advantage of the emitted light. Moreover, the partial light will form spot in outside of the illuminated area which result in a poor light effects.

Therefore, it is necessary to provide a lens device and the LED strip light having the same to settle out the above art problem.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is an isometric view of an LED strip light according to an embodiment.

FIG. 2 is an isometric exploded view of the LED strip light of FIG. 1.

FIG. 3 is a sectional view of the LED strip light of FIG. 1 taken along a line of A-A.

FIG. 4 is a light path view of the spread-light lens of the LED strip light of FIG. 2

FIG. 5 is a schematic view of a cross section of the spread-light lens of the LED strip light of FIG. 2 taken along an optical axis.

### DETAILED DESCRIPTION

The present application is illustrated by way of example and not by way of limitation in the figures of the accompanying drawings. It should be noted that references to “an” or “one” embodiment in this application are not necessarily to the same embodiment, and such references mean at least one.

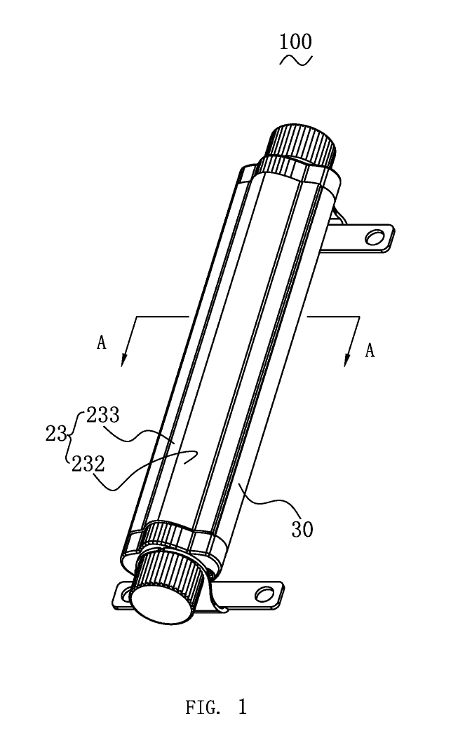

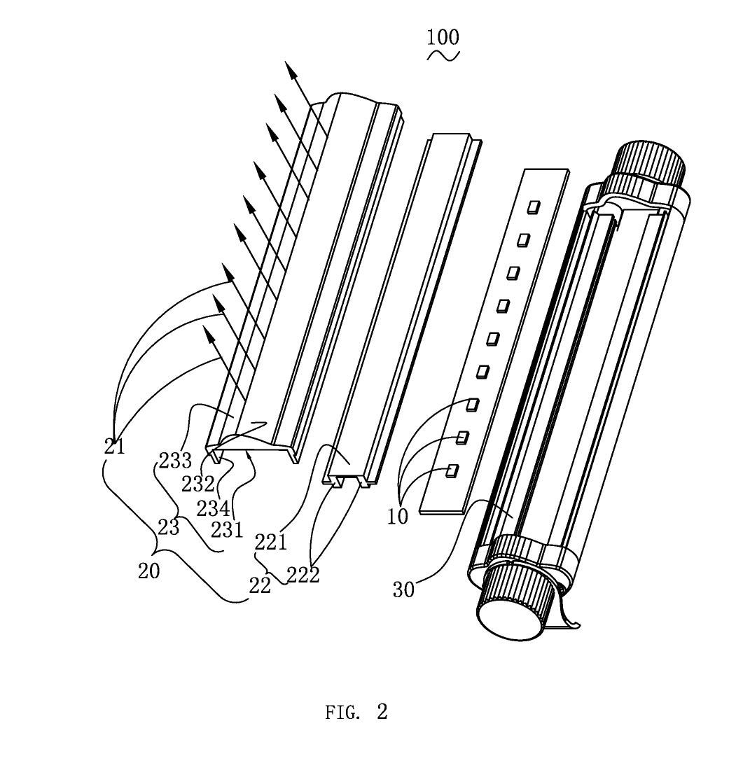

Referring to FIG. 1 and FIG. 2, an LED strip light 100 according to an embodiment is shown. The LED strip light 100 includes at least one LED chip 10, a lens device 20 arranged on the at least one LED chip 10 along light direction thereof, and a strip-typed holder 30 configured for housing all of components of the LED strip light 100. It may be understood that the LED strip light 100 further includes end covers, wires, LED drivers, and son on. These function modules are well known for an ordinary person skilled in the art, and not necessary to described in detail.

Referring to FIG. 2, the LED (it is a short of Light Emitting Diode, hereinafter) chip 10 function as a light source so as to emit light. As well known that the LED chip 10 is a semiconductor light source and transforms power into light. The LED chip 10 presents many advantages over traditional light sources including lower energy consumption, longer lifetime, improved physical robustness, smaller size, and faster switching. The LED strip light 100 may only have one LED chip 10 or a lots of LED chips 10. In the present embodiment, the LE strip light 100 has a lots of LED chips 10. Understandably, each of the lots of the LED chips 10 may be acted as a light source and arranged on a printed circuit board at same interval each other

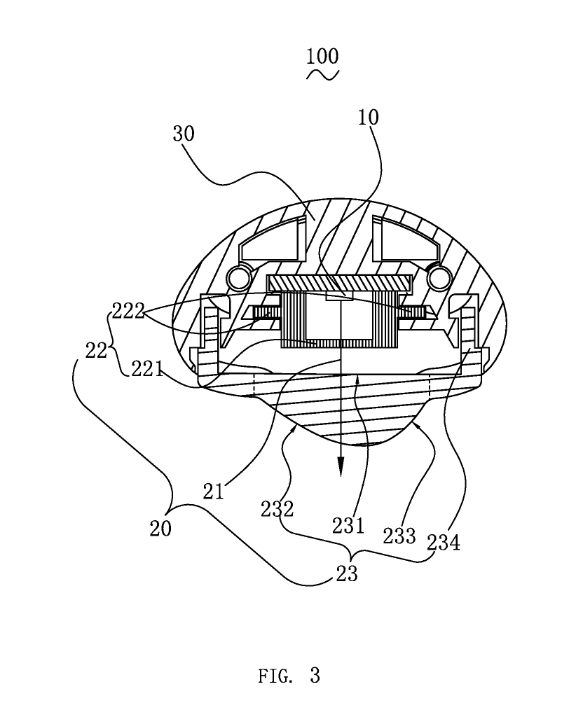

Referring to FIG. 3 together, the lens device 20 includes at least one optical axis 21, a diffuser plate 22 being perpendicular to the at least one optical axis 21, and a spread-light lens 23 disposed on the diffuser plate 22. The diffuser plate 22 and the spread-light lens 23 may be two independent components respectively as long as the spread-light lens 23 is perpendicular to the optical axis 21 and is mounted on the diffuser plate 22. However, in order to be convenient to assemble as a whole, the spread-light lens 23 is integrated into the diffuse plate 23 in the present embodiment. The spread-light lens 23 includes a plane light incidence surface 231 being perpendicular to the optical axis 21, and a first convex light emitting surface 232 and a second convex light emitting surface 233 which lie in two sides of the at least one optical axis 21 respectively. On a cross section taken along the at least one optical axis 21, an arc length and a radius of curvature of a profile of the first convex light emitting surface 232 is larger than that of a profile of the second convex light emitting surface 233. Furthermore, an irradiation distance of emergent light of the first convex light emitting surface is less than that of emergent light of the second convex light emitting surface 233.

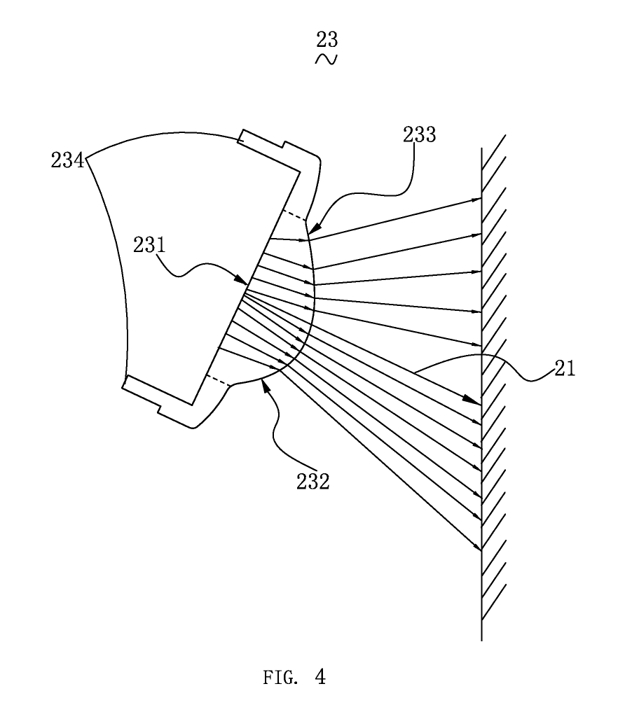

Referring to FIG. 4, the optical axis 21 is used to clearly and compactly describe the specific structure of the Lens device 20 and the relative position of the lens device 20 with the LED chip 10. The optical axis 21 is a universal feature for all of lens and used to dispose the light source, namely the LED chip 10. Moreover, the optical axis 21 is a guide for optic design. The optical axis 21 is overlapped with the centre line of the LED chip 10. That is to say, the optical axis 21 crosses through the center of the plane light incidence surface 231 and is perpendicular to the plane light incidence surface 231. Moreover, the first convex light emitting surface 232 and the second convex light emitting surface 233 are positioned at two sides of the optical axis 21 along length direction of the spread-light lens 23. Therefore, luminous flux received by the first convex light emitting surface 232 is same as that by the second convex light emitting surface 233.

Referring to FIG. 2 and FIG. 3 again, the diffuser plate 22 is perpendicular to the optical axis 21 and is configured for diffusing the point light source into area source. The diffuse plate 22 may be manufactured via the glass plate, polystyrene plate, polycarbonate plate, and so on which is processed by dull polish method. A beam angle of the diffuse plate 22 can be of 90 degrees to 150 degrees. Understandably, the beam angle of the diffuse plate 22 can be set on the basis of range of exposure, and irradiation distance, and so on. In the present embodiment, the beam angle of the diffuse plate 22 is 120 degrees. Furthermore, the diffuser plate 22 includes a body 221, and two steps 222 respectively disposed two sides of the body 221. The body 221 is configured for diffusing the light emitted forward of the LED chip 10. The two steps 222 are respectively plugged into the strip-typed holder 30. In the present embodiment, the body 221 has a strip-typed plate so as to diffuse light. The two steps 222 extend along the opposite direction of the optical axis 21. The body 221 is arranged with the LED chip 10 at interval because of the support of the two steps 222 so as that the emergent light of the LED chip 10 can go into the body 221 as many as possible. The body 221 is integrated into the two steps 222 so as to be convenient to assembly.

Referring to FIG. 3 and FIG. 4, in the present embodiment, the spread-light lens 23 is arranged with the diffuser plate 22 at interval so that the plane light incidence surface 231 can have a larger area for optical design. The plane light incidence surface 231 is a plane so as to regulate the incident angle of incident light for optical design.

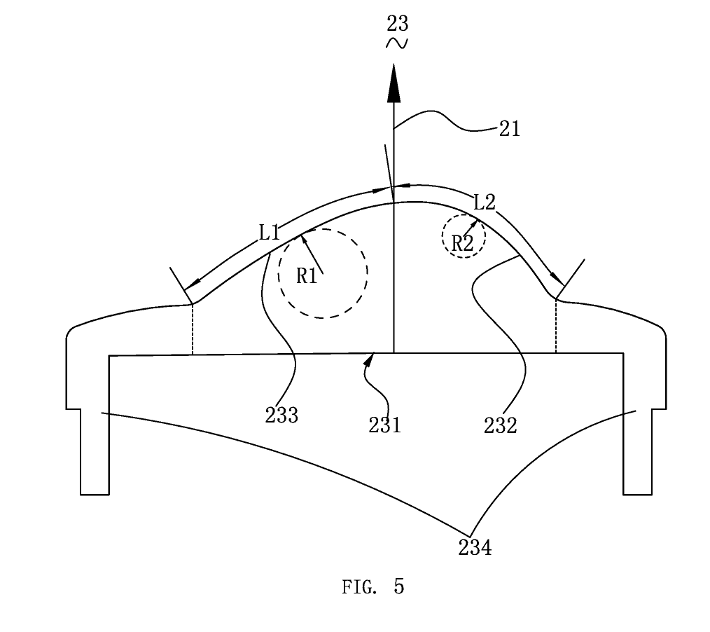

Referring to FIG. 5, the arc length and the radius of curvature of the first convex light emitting surface 232 on the cross section taken along the optical axis 21 are respectively marked as L1 and R1. The arc length and the radius of curvature of the second convex light emitting surface 233 on the cross section along the optical axis 21 are respectively marked as L2 and R2. Therefore, the relation of L1 and L2 is L1>L2 and the relation of the R1 and R2 is R1>R2. In the present embodiment, the spread-light lens 23 further includes two lockers 234. The two lockers 234 are respectively disposed on two sides of the first convex light emitting surface 232 and the second convex light emitting surface 233. The two lockers 234 extend along opposite direction of the optical axis 21 and clamp onto the strip-typed holder 30. Understandably, the two lockers 234 are only used to assemble the spread-light lens 23 and have no optical function. In order to distinguish the two lockers 234 with the first, second convex light emitting surface 232, 233, two boundary lines of dash lines are added between the two lockers 234 and the first, second convex light emitting surface 232, 233. As well known, the first, second convex light emitting surface 232, 233 have convergence function. However, since the first convex light emitting surface 232 has larger radius of curvature than the second convex light emitting surface 233, the second convex light emitting surface 233 has stronger convergence effect than the first convex light emitting surface 232 when the second convex light emitting surface 233 illuminates the illuminated area which is closer to the LED strip light 100 and the first convex light emitting surface 232 illuminates the illuminated area which is farther to the LED strip light 100.

Further, the first convex light emitting surface 232 may have the arc length of 6 mm to 10 mm, and the second convex light emitting surface 233 may have the arc length of 3 mm to 5 mm. The first convex light emitting surface 232 may have the radius of curvature of 12 mm to 15 mm, and the second convex light emitting surface 233 may have the radius of curvature of 4 mm to 11 mm.

In use, since the first convex light emitting surface 232 has larger arc length and radius of curvature than the second convex light emitting surface 233 on the cross section taken along the optical axis 21, the second convex light emitting surface 233 has stronger convergence effect than the first convex light emitting surface 232. As well known that the light source having stronger convergence effect has less illuminated area and luminous flux in unit area will larger on the premise that they have same irradiation distance. Moreover, as a light beam has scattering ability, the luminous flux will less when the irradiation distance and illuminated area is larger. Therefore, the light source having stronger convergence effect can make up the intensity losses of attenuation because of larger irradiation distance. As a result, the illumination pattern which is closer to the LED strip light 100 and formed by the first convex light emitting surface 232 has same luminance with the illumination pattern which is father to the LED strip light 100 and formed by the second convex light emitting surface 233. That is to say, the LED strip light 100 have uniform illumination pattern.

Referring to FIG. 1 to FIG. 3, the strip-typed holder 30 is used to house all of components. The strip-typed holder 30 may be made of random material, such as aluminum, and so on. Understandably, the strip-typed holder 30 has some grooves opened thereon to dispose the two steps 222 and two lockers 234.

As described above, the lens device 20 of the invention can diffuse the emergent light of the LED chip 10 into area source via the diffuser plate 22 and converge the emergent light of the diffuser plate 22 into the finial emergent light having a less beam angle. In result, an uniform illumination pattern is obtain in the beam angle. Comparing with the second convex light emitting surface 233, the first convex light emitting surface 232 has weaker convergence ability as it has larger are length and radius of curvature on the cross section taken along the optical axis 21. As a result, the illumination pattern which is closer to the LED strip light 100 and formed by the first convex light emitting surface 232 has same luminance with the illumination pattern which is father to the LED strip light 100 and formed by the second convex light emitting surface 233. That is to say, the LED strip light 100 have uniform illumination pattern.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A lens device, comprising:
at least an optical axis;
a diffuser plate being perpendicular to the at least one optical axis, the diffuser plate being configured for diffusing the point light source into area source; and
a spread-light lens disposed on the diffuser plate and comprising a plane light incidence surface being perpendicular to the at least one optical axis, and a first convex light emitting surface and a second convex light emitting surface which are positioned at two sides of the at least one optical axis respectively, on a cross section taken along the at least one optical axis, an arc length and a radius of curvature of a profile of the first convex light emitting surface being larger than that of a profile of the second convex light emitting surface, an irradiation distance of emergent light of the first convex light emitting surface being less than that of emergent light of the second convex light emitting surface.

2. The lens device as claimed in claim 1, wherein the spread-light lens is arranged with the diffuser plate at interval.

3. The lens device as claimed in claim 1, wherein the spread-light lens is integrated into the diffuse plate.

4. The lens device as claimed in claim 1, wherein a beam angle of the diffuser plate is of 90 degrees to 150 degrees.

5. The lens device as claimed in claim 1, wherein the arc length of the first convex light emitting surface is of 6 mm to 10 mm, the second convex light emitting surface has the arc length of 3 mm to 5 mm.

6. The lens device as claimed in claim 1, wherein the first convex light emitting surface has the radius of curvature of 12 mm to 15 mm, the second convex light emitting surface has the radius of curvature of 4 mm to 11 mm.

7. An LED strip light, comprising:
at least one LED chip;
a lens device, comprising:
at least one optical axis, the optical axis having same amount with the LED chip and each of the at least one optical axis being corresponding to one of the at least one LED chip;
a diffuser plate being perpendicular to the at least one optical axis, the diffuser plate being configured for diffusing the point light source into area source; and
a spread-light lens disposed on the diffuser plate and comprising a plane light incidence surface being perpendicular to the at least one optical axis, and a first convex light emitting surface and a second convex light emitting surface which are positioned at two sides of the at least one optical axis respectively, on a cross section taken along the at least one optical axis, an arc length and a radius of curvature of a profile of the first convex light emitting surface being larger than that of a profile of the second convex light emitting surface, irradiation distance of emergent light of the first convex light emitting surface being less than that of emergent light of the second convex light emitting surface.

8. The LED strip light as claimed in claim 7, wherein the lens device has a strip type and the LED strip light comprises a lot of LED chips, the LED chips are arranged alone the length direction of the lens device.

9. The LED strip light as claimed in claim 8, wherein the LED strip light comprises a strip-typed holder, the diffuser plate comprises a body and two steps respectively disposed two sides of the body, the body is configured for diffusing the light emitted forward of the LED chip, the two steps extend alone the opposite direction of the optical axis and are plugged into the strip-typed holder.

10. The LED strip light as claimed in claim 8, wherein the LED strip light comprises a strip-typed holder, the spread-light lens further comprises two lockers respectively disposed on two sides of the first convex light emitting surface and the second light emitting surface, the two lockers extend along opposite direction of the optical axis, the two lockers clamp onto the strip-typed holder.
